(19) United States
(12) Patent Application Publication
(10) Pub. No.: US 2011/0252891 A1
(43) Pub. Date: Oct. 20, 2011

(54) Method and Apparatus for Determining Topography of an Object

(75) Inventors: Vladimir Cherman, Heverlee (BE); Jeroen De Coster, Kessel-lo (BE)

(73) Assignee: IMEC, Leuven (BE)

(21) Appl. No.: 13/133,199

(22) PCT Filed: Dec. 7, 2009
(86) PCT No.: PCT/EP09/66558

§ 371 Date: Jun. 7, 2011

Related U.S. Application Data
(60) Provisional application No. 61/120,736, filed on Dec. 8, 2008.

(51) Int. Cl. G01N 21/41

(52) U.S. Cl. 73/657

(57) ABSTRACT

A method for determining the topography of a static surface (305) of an object (301) comprises the steps of: (a) selecting a region (301a) on the static surface (305) of the object (301); (b) directing an incident monochromatic electromagnetic wave (302) onto the region (301a) while the surface (305) and the incident monochromatic electromagnetic wave (302) are moved relative to one another, the incident monochromatic electromagnetic wave (302) being characterised by a frequency f₀, an amplitude A₀ and a propagation direction, the direction of movement (304) being substantially not parallel to the propagation direction of the incident monochromatic electromagnetic wave (302), wherein the surface (305) reflects the incident monochromatic electromagnetic wave (302) thus generating a reflected monochromatic electromagnetic wave (303), the movement (304) being characterized by a movement frequency (F) and a movement amplitude (A); (c) determining properties of the monochromatic electromagnetic wave (303) reflected from the region (301a) during the movement (304); and (d) analyzing properties, e.g. frequency f₀, of the incident monochromatic electromagnetic wave (302) and the properties, e.g. frequency fᵣ, of the reflected monochromatic electromagnetic wave (303) to obtain information about the topography of the region (301a) of the object (301). A corresponding system is also provided.

### FIELD OF THE INVENTION

It is an aim of the invention to provide a method for acquiring information about the profile of both small and relatively large sample areas (μm to cm range) with sub-nm, e.g. pm, out-of-plane resolution and with the possibility to do this in different environments (for example through glass of a vacuum or environmental chamber; for samples on a hot stage etc).

### BACKGROUND OF THE INVENTION

Profilometry is a general term standing for techniques being used to acquire information about the shape (or profile) of an object or its surfaces. One can distinguish between contact techniques implemented for example in contact profilometers or atomic force microscopes (AFM), and optical techniques allowing contactless profilometry. The AFM has the advantage of a very high vertical resolution, which is in the order of a few angstroms. However, it is very slow and can hardly be used to scan areas larger than 100 μm. In addition, large vertical steps (e.g. >5 μm) cannot be measured. Another drawback of this method is the difficulty to combine it with environmental test equipment, e.g. temperature and/or vacuum chambers, hot stages etc. Existing optical techniques, e.g. optical interferometry, can in general be much faster but as a drawback show a worse resolution, which is usually not better than a few nanometers. These existing techniques all have in common that the larger the area one wants to scan, the lower the out-of-plane (i.e. not in the plane of the object) resolution or the larger the required time.

Laser Doppler Vibrometry (LDV), as illustrated in FIG. 1, is a non-contact optical method based on the use of an interferometer to measure the Doppler frequency shift of incident light 202 with amplitude A₀ and frequency f₀ scattered by a vibrating object 201. The vibration of the object 201, a movement with a velocity V, is typically in a direction parallel to the incident laser beam 202, i.e. out-of-plane with respect to the plane of the object 201 as shown in FIG. 1. The motion of the object 201 relative to the light source 200 causes a shift of the amplitude of the reflected light beam 203 towards a value Aᵣ, and a shift of the frequency of the reflected light beam 203 towards a value fᵣ as described by Doppler equations. From the Doppler frequency shift (Δf=fᵣ−f₀) the (vibrating) velocity V of the object 201 may be determined by solving the Doppler equation:

$$Δ f = {f}_{r} - {f}_{0} = \frac{2 V}{λ} ,$$

with fᵣ being the frequency of the reflected light beam 203, f₀ being the frequency of the incident light beam 202 from the laser source 200, V being the velocity of the vibrating object 201, λ being the wavelength of the incident light beam 202. Laser Doppler vibrometry (LDV) is a very sensitive optical technique capable of achieving sub-nanometer and even sub-picometer resolution.

One of the advantages of laser Doppler vibrometry is that it can be easily integrated with different temperature and vacuum chambers and can be used to scan over relatively large areas. So, it combines both the required resolution and applicability domain. However, this method is based on a detection of mechanical (vibrational) out-of-plane movements (speed and displacement) of an object and thus it can not be directly applied to measure the profile of the object. This method is widely used to measure dynamic properties of electromechanical systems and to investigate mechanical resonances of purely mechanical systems.

### SUMMARY OF THE INVENTION

It is an object of embodiments of the present invention to provide a method and a device for determining profile of an object in a non-destructive way.

The above object is accomplished by a method and a system according to embodiments of the present invention.

In a first aspect, the present invention provides a method for determining the topography of a static surface of an object. The method comprises:

(a) selecting a region on the static surface;
(b) directing an incident monochromatic electromagnetic wave onto the region while the surface and the incident monochromatic electromagnetic wave are moved relative to one another,
the incident monochromatic electromagnetic wave being characterized by a frequency f₀, an amplitude A₀ and a propagation direction,
the direction of movement being substantially not parallel to the propagation direction of the incident monochromatic electromagnetic wave,
wherein the surface reflects the incident monochromatic electromagnetic wave thus generating a reflected monochromatic electromagnetic wave, the movement being characterized by a movement frequency and movement amplitude;
   (c) determining properties of the monochromatic electromagnetic wave reflected from the region during the movement, and
   (d) analyzing properties of the incident monochromatic electromagnetic wave and the properties of the reflected monochromatic electromagnetic wave to obtain information about the topography of the region of the object.

It is an advantage of embodiments of the present invention that topography of a surface may be determined with high spatial resolution, more specifically high vertical or out-of-plane resolution.

With out-of-plane resolution is meant a resolution out of the plane of the surface to be characterised. More specifically it is an advantage of embodiments of the present invention that topography of a surface may be defined with sub-angstrom resolution, more specifically for example picometer resolution.

It is an advantage of embodiments of the present invention that new functionality is added to an existing LDV system, more specifically for example the possibility of topographical measurements on wafer level including measurements inside vacuum- or environmental-probe station.

It is an advantage of embodiments of the present invention that topography of a surface can be determined in a non-destructive way.

In a method according to embodiments of the present invention, the relative movement may comprise a displacement of the surface and/or of the incident monochromatic electromagnetic wave.

The displacement may be induced by a mechanical, electromagnetic, or piezoelectric force to the surface and/or to a source generating the incident monochromatic electromagnetic wave. In alternative embodiments, the displacement of the incident monochromatic electromagnetic wave may be induced by moving at least a mirror which lies in the propagation path of the incident monochromatic electromagnetic wave.

In a method according to embodiments of the present invention, the relative movement is a reciprocating linear movement. In alternative embodiments, the relative movement is a circular movement.

The displacement may be a reciprocating displacement of the surface induced by providing a holder for the surface and inducing the reciprocating displacement to the holder.

In a method for determining the topography of a static surface according to embodiments of the present invention, an angle between the propagation direction of the incident monochromatic electromagnetic wave and the direction of movement is in the range of 40 degrees to 90 degrees, for example about 90 degrees.

In particular method embodiments, the properties of the incident and reflected monochromatic electromagnetic waves comprise at least the frequency of the incident and reflected monochromatic electromagnetic waves, respectively.

In such cases, the step of analyzing properties may comprise:
determining a Doppler frequency shift, being the difference between the frequency of the incident monochromatic electromagnetic wave and the frequency of the reflected monochromatic electromagnetic wave;
calculating a topographical slope value from the Doppler frequency shift and the movement frequency and movement amplitude of the relative movement;
integrating the topographical slope value, wherein the integrated topographical slope value determines the topographical property of the region.

It is an advantage of embodiments of the present invention that the topography can be determined using an existing tool with an initial purpose of measuring vibrating movements based on Doppler effect, such as e.g. a Laser Doppler Vibrometer.

A method according to embodiments of the present invention may further comprise:

(e) selecting another region on the static surface; and
(f) repeating steps (b) to (d) for this another region and, if required, steps (e) and (f) for yet another region until the topography of the complete surface to be determined is determined.

It is an advantage of embodiments of the present invention that the topography can be determined for large surface areas, e.g. surface areas in the range of 1 μm up to several cm or even higher.

The method may further comprise, before step (f), moving the incident monochromatic electromagnetic wave from the region to the another region with a scanning velocity and a scanning amplitude. Moving the incident monochromatic electromagnetic wave from the region to the another region may occur according to a predetermined path. Moving the incident monochromatic electromagnetic wave may be performed in one dimension or in two dimensions.

It is an advantage of embodiments of the present invention that a raster scan can be performed in order to measure the overall topography of the object.

In a method for determining the topography of a static surface according to embodiments of the present invention, the movement frequency may be different from a mechanical resonance frequency of the object.

It is an advantage of embodiments of the present invention that overall topography of a static object is determined. There are no external movements which induce a vibrational movement of the surface of the object (for example due to resonance frequency or for example due to an external applied movement).

A method for determining the topography of a static surface according to alternative embodiments of the present invention may further comprise the steps of:
providing a reference monochromatic electromagnetic wave,
directing the reference monochromatic electromagnetic wave onto the object wherein the object reflects the reference monochromatic electromagnetic wave,
determining the properties of the reflected reference monochromatic electromagnetic wave, wherein the analyzing step comprises analyzing the properties of the incident monochromatic electromagnetic wave, the reflected monochromatic electromagnetic wave, the incident monochromatic reference electromagnetic wave and the reflected monochromatic reference electromagnetic wave to obtain information about the topography of the surface. In a second aspect, the present invention provides a system for measuring topography of a static surface. Such system comprises:
a monochromatic electromagnetic wave source for generating a monochromatic electromagnetic wave;
optics for directing the monochromatic electromagnetic wave to the surface, so as to generate a reflected monochromatic electromagnetic wave from the surface,
a shaker to move the surface and the monochromatic electromagnetic wave relative to one another, the direction of movement being substantially not parallel to the propagation direction of the incident monochromatic electromagnetic wave, the movement being determined by a moving frequency and moving amplitude;
a detector for detecting properties of the reflected monochromatic electromagnetic wave;
an analyzer for analyzing properties of the incident monochromatic electromagnetic wave and the properties of the reflected monochromatic electromagnetic wave;
a convertor for converting the analyzed data into a topography property of the surface.

A system according to embodiments of the present invention may further comprise:
a scanner for inducing an additional relative movement between the surface and the monochromatic electromagnetic wave, the additional relative movement comprising scanning the surface from a first region towards another region of the surface with a velocity and distance, wherein the scanning distance is higher than the movement amplitude and wherein the scanning velocity is smaller than the movement frequency.

In a third aspect, the present invention provides the use of a Laser Doppler vibrometer for determining the topography of a surface, wherein a relative movement of a monochromatic electromagnetic wave and an object is induced in a direction not parallel to the propagation direction of the monochromatic electromagnetic wave.

Particular and preferred aspects of the invention are set out in the accompanying independent and dependent claims. Features from the dependent claims may be combined with features of the independent claims and with features of other dependent claims as appropriate and not merely as explicitly set out in the claims.

For purposes of summarizing the invention and the advantages achieved over the prior art, certain objects and advantages of the invention have been described herein above. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

### DESCRIPTION OF THE DRAWINGS

FIG. 1 (PRIOR ART) shows a schematic representation of laser Doppler vibrometry.

FIG. 2 is a block diagram illustrating a method according to an embodiment of the present invention.

FIG. 3 is a schematic representation of a setup in accordance with first embodiments of the present invention.

FIG. 4 illustrates how the profile of a surface may be expressed in function of distance.

FIG. 5 is a schematic representation of a setup in accordance with second embodiments of the present invention, where a plurality of regions are scanned.

FIG. 6 illustrates raster scanning over a particular type of topography.

FIG. 7 illustrates circular scanning over a plurality of regions.

FIG. 8 illustrates an embodiment of the present invention where the object of which the topography is to be determined is tilted.

FIG. 9 is a block diagram illustrating an alternative method according to embodiments of the present invention.

FIG. 10 illustrates an experimental setup of a device according to embodiments of the present invention.

FIG. 11 illustrates an example of a measurement result of a line scan over a feedthrough.

FIG. 12 illustrates the resulting topography profile of the measurement illustrated in FIG. 11, after integrating the local slope.

FIG. 13 is a schematic representation of a setup in accordance with third embodiments of the present invention, where the relative movement between the surface and the incident monochromatic electromagnetic wave is provided by means of at least one moveable mirror.

FIG. 14 shows an overall profile of a measured frequency shift, and a detailed part thereof.

FIG. 15 is a block diagram illustrating an alternative method according to embodiments of the present invention.

FIG. 16 illustrates how the relative movement between the surface and the incident monochromatic electromagnetic wave leads to an apparent out-of-plane movement due to the topography profile.

Any reference signs in the claims shall not be construed as limiting the scope.

In the different drawings, the same reference signs refer to the same or analogous elements.

### DETAILED DESCRIPTION OF THE INVENTION

One or more embodiments of the present invention will now be described in detail with reference to the attached figures; the invention is not limited thereto. The drawings described are only schematic and are non-limiting. In the drawings, the size of some of the elements may be exaggerated and not drawn on scale for illustrative purposes. The dimensions and the relative dimensions do not necessarily correspond to actual reductions to practice of the invention. Those skilled in the art can recognize numerous variations and modifications of this invention that are encompassed by its scope. Accordingly, the description of preferred embodiments should not be deemed to limit the scope of the present invention; the scope of the present invention being defined by the appended claims. Furthermore, the terms first, second and the like in the description are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description are used for descriptive purposes and not necessarily for describing relative positions. The terms so used are interchangeable under appropriate circumstances and the embodiments of the invention described herein can operate in other orientations than described or illustrated herein. For example “underneath” and “above” an element indicates being located at opposite sides of this element.

Reference throughout this specification to “one embodiment” or “an embodiment” means that a particular feature, structure or characteristic described in connection with the embodiment is included in at least one embodiment of the present invention. Inventive aspects may lie in less than all features of a single foregoing disclosed embodiment.

It is to be noticed that the term “comprising”, used in the description and claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

In the description provided herein, numerous specific details are set forth. However, it is understood that embodiments of the invention may be practiced without these specific details. In other instances, well-known methods, structures and techniques have not been shown in detail in order not to obscure an understanding of this description.

In the present invention, when the term ‘laser’ is used, it encompasses any kind of monochromactic electromagnetic waves including monochromatic electromagnetic waves. More specifically when the term ‘laser’ is used, it may comprise any kind of coherent monochromatic electromagnetic waves, including laser coherent monochromatic electromagnetic waves. An example of a laser suitable for embodiments of the present invention is a Helium-neon laser (HeNe laser). Another example of a suitable laser is a neodymium-doped yttrium aluminium garnet laser (Nd:YAG laser).

The term ‘static’ means that the shape is preserved. A static surface means that the shape of the surface is preserved, otherwise said the shape of the surface does not change. The profile of the surface does not change. More specifically the topographic property of the surface does not change. Otherwise said the topographic property of the surface remains unchanged. This also means that a movement of the surface does not affect the shape (profile, topography) of the surface. If the surface comprises different parts, the relative position of these parts to each other remains unchanged. If the surface for example comprises any freestanding or protruding parts, the surface is static as long as these freestanding or protruding parts do not move relative to other parts of the surface. For example for a MEMS device comprising a cantilever, a static surface of this MEMS device means the cantilever is not vibrating. If an external movement is applied to the surface, the surface must remain static, meaning that the external movement may not induce any movements of the surface other than the applied external movement. As the method and system according to embodiments of the present invention are based on a laser Doppler principle, static may also mean that there is substantially no out-of-plane movement such as for example a vibrational out-of-plane movement of the surface.

When the term ‘shaker’ is used, it encompasses all kinds of devices or systems adapted for moving an object. In particular embodiments of the present invention, a ‘shaker’ refers to a device or system for applying an in-plane movement of an object, hence of its surface.

When the term ‘surface’ is used, it means the surface of an object. The surface may be a top surface of the object. Whenever the term ‘object’ is used it also refers to the surface of the object.

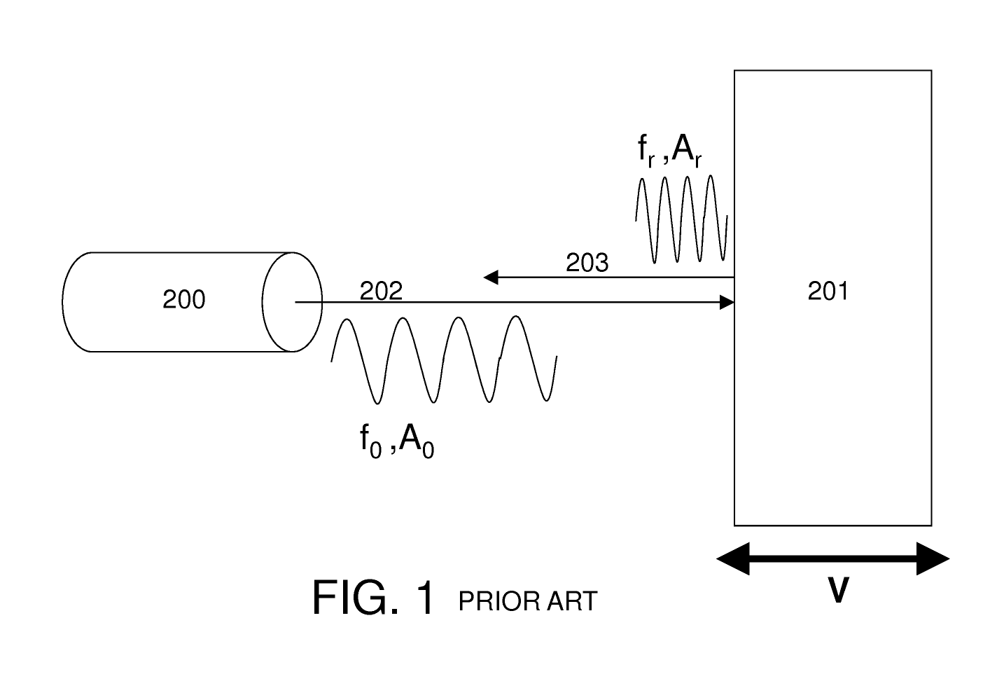

The method and apparatus of the present invention are based on the measurement principle of laser Doppler vibrometry (LDV). State of the art Laser Doppler vibrometry (FIG. 1) is based on measurement of the Doppler frequency shift of a laser signal 203 that is reflected off an object 201 that moves with respect to the laser source 200 (Doppler effect). The movement of the object 201 is typically out-of-plane, meaning in a direction which is substantially in the direction of the laser signal 202, e.g. towards and/or away from the laser source 200. The amount of frequency shift is a measure of the velocity V of the moving object 201. In state of the art laser Doppler vibrometry, the incident laser signal 202 from the laser Doppler vibrometer is therefore directed at the moving object, more specifically the vibrating surface of interest 201. The vibration amplitude and the vibration frequency are extracted from the Doppler frequency shift of the laser beam frequency due to the motion of the surface.

A fundamental difference with optical profilometry tools (such as white light interferometry) is the fact that velocity is being measured: a conventional laser Doppler vibrometer only allows measuring a (time-dependent) movement, not a static topography.

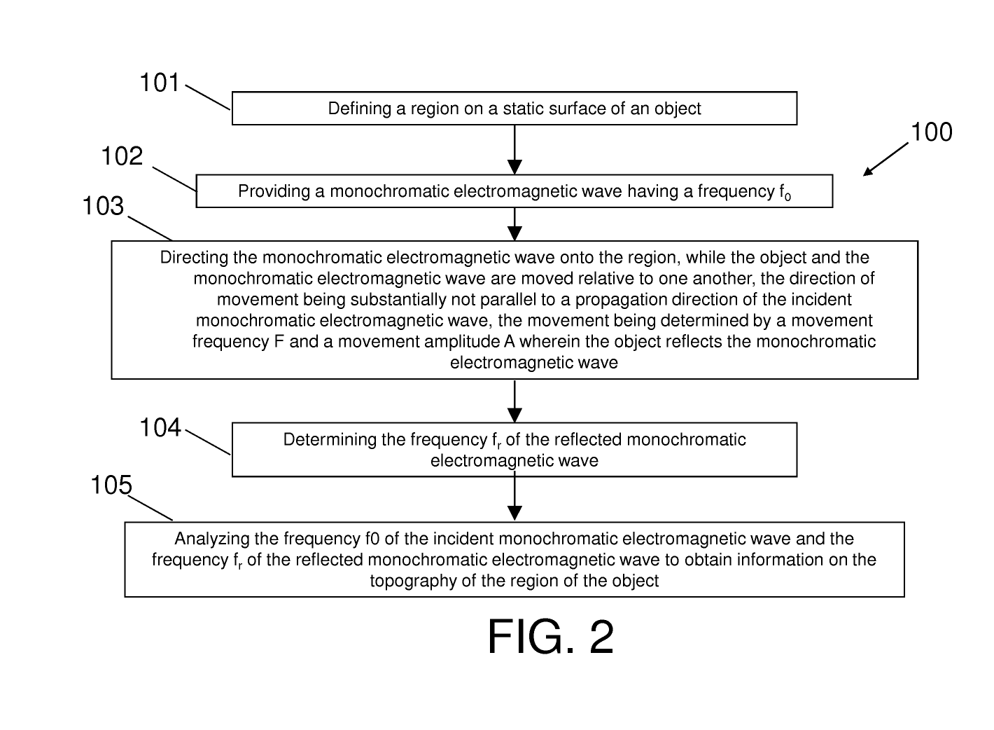

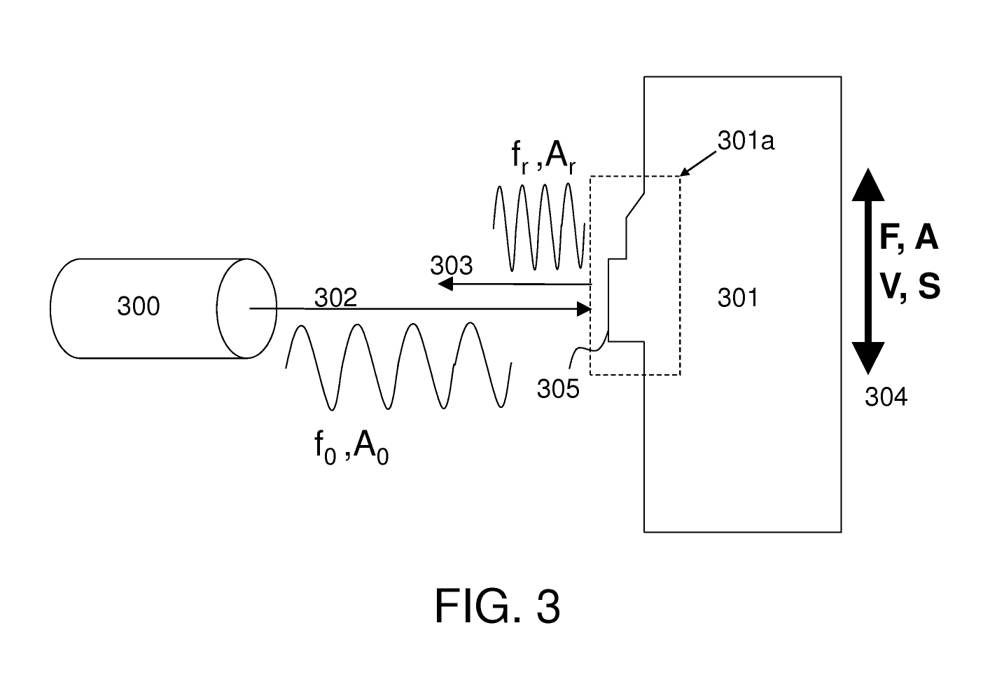

A first aspect of the present invention relates to a method 100 (illustrated in a block diagram in FIG. 2, and with reference to a set-up as for example illustrated in FIG. 3) for determining the topography of a static surface 305 of an object 301, the method comprising the steps of:

(a) selecting a region 301a on the static surface 305 of the object 301—step 101;
(b) providing a monochromatic electromagnetic wave 302—step 102;
(c) directing the monochromatic electromagnetic wave 302 onto the region 301a while the surface 305 and the incident monochromatic electromagnetic wave 302 are moved relative to one another—step 103,
the incident monochromatic electromagnetic wave 302 being characterized by a frequency f₀, an amplitude A₀ and a propagation direction,
the direction of movement being substantially not parallel to the propagation direction of the incident monochromatic electromagnetic wave 302,
wherein the surface 305 reflects the incident monochromatic electromagnetic wave 302 thus generating a reflected monochromatic electromagnetic wave 303, the movement being characterized by a movement frequency F and a movement amplitude A;
   (d) determining properties of the monochromatic electromagnetic wave 303 reflected from the region 301a during the movement—step 104, and
   (e) analyzing the properties of the incident monochromatic electromagnetic wave 302 and the properties of the reflected monochromatic electromagnetic wave 303 to obtain information about the topography of the region 301a of the object 301—step 105.

In the following each of the different steps will be explained in more detail, with reference to FIG. 2 and FIG. 3.

A static object 301 (FIG. 3), i.e. an object having a static surface 305, is provided and a region 301a is defined on the static surface 305 of this object 301. The surface 305 may for example be a top surface of the object 301. A static surface 305 may be a non-vibrating surface, e.g. a surface having no vibrating parts. There is no change of the shape or profile of the surface 305 due to the applied movement between the object 301 and the incident monochromatic electromagnetic wave 302.

A monochromatic electromagnetic wave 302 having a frequency f₀ and an amplitude A₀ is provided. The monochromatic electromagnetic wave 302 may be a coherent monochromatic electromagnetic wave such as a monochromatic electromagnetic wave. In another embodiment, the monochromatic electromagnetic wave may be a highly collimated monochromatic electromagnetic wave. A laser source 300, such as for example a HeNe laser source, may provide such a monochromatic electromagnetic wave. For a HeNe laser source a laser beam with a frequency f₀ of about 4.74e14 Hz and a wave length of about 633 nm is provided.

The monochromatic electromagnetic wave 302 is directed onto the region 301a of the static surface 305 while the surface 305 is moved 304 relative to the monochromatic electromagnetic wave 302. The movement has a movement frequency F and a movement amplitude A. The direction of the relative movement 304 is substantially not in the plane of the incident monochromatic electromagnetic wave. With substantially not in the plane of the incident monochromatic electromagnetic wave is also meant substantially not parallel to the propagation direction of the incident monochromatic electromagnetic wave. With substantially not in the plane of the incident monochromatic electromagnetic wave 302 is meant that there is thus no out-of-plane movement of the surface 305 with respect to the plane of the object 301, such as typically used in state of the art laser Doppler vibrometry. Substantially not in the plane of the incident monochromatic electromagnetic wave 302 also means that there is no out-of-plane (out of the plane of the surface 305 of the object 301) vibrating movement of the surface 305. The relative movement between the surface 305 and the monochromatic electromagnetic wave 302 is substantially in-plane, which means in the plane of the surface 305.

In particular embodiments of the present invention, the propagation direction of the monochromatic electromagnetic wave 302 is substantially perpendicular to the direction of movement 304 of the surface 305 of which the topographic properties are to be determined. The angle between the propagation direction of the incident monochromatic electromagnetic wave 302 and the direction of movement of the surface 305 may be about 90°, i.e. in the range of 65° to 115°. The angle between the propagation direction of the incident monochromatic electromagnetic wave 302 and the direction of movement of the surface 305 may also be in a range between 10° and 90°, more specifically for example between 40° and 90°.

The propagation direction of the monochromatic electromagnetic wave 302 incident on the surface 305 may not be parallel to the direction of movement 304 of the surface 305. If the monochromatic electromagnetic wave source 300 emits a monochromatic electromagnetic wave with a propagation direction substantially not perpendicular to the direction of movement 304 of the surface 305 of the object 301, additional optics (not illustrated) such as mirrors may be required to route the incident and reflected monochromatic electromagnetic waves 302, 303 in a direction which is substantially perpendicular to direction of movement 304 of the surface 305.

The relative movement may include moving the surface 305 with respect to the incident monochromatic electromagnetic wave 302 and/or moving the incident monochromatic electromagnetic wave 302 with respect to the surface 305.

In embodiments of the present invention, the relative movement may be induced by a mechanical, electromagnetical, piezoelectrical force or by any other method that provides a displacement of the surface 305. The surface 305 may be mounted on a holder which is arranged to induce a movement of the surface 305, for example a shaker or a moving stage.

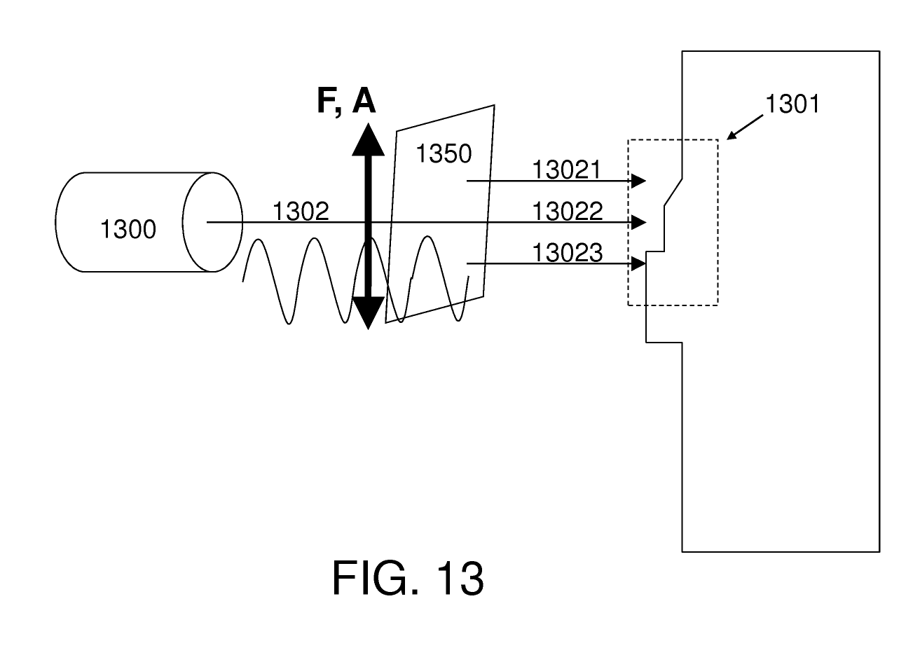

In the above or alternative embodiments, moving the incident monochromatic electromagnetic wave 302 may be induced by moving the source 300 providing the monochromatic electromagnetic wave. For a laser beam, this can be the laser source. In another embodiment, moving the monochromatic electromagnetic wave 302 may be performed by using a stationary source 300 for providing a monochromatic electromagnetic wave and movable optics such as for example mirrors (as illustrated for one embodiment in FIG. 13). Moving the mirrors 1350, which are typically placed in the path of the incident electromagnetic wave 1302, may be done by inducing a harmonic oscillation to the mirror 1350 such that the mirror is moved or rotated with a high frequency as such inducing a movement of the incident electromagnetic wave 13021, 13022, 13023.

The relative movement 304 may be defined by a movement amplitude A and a movement frequency F.

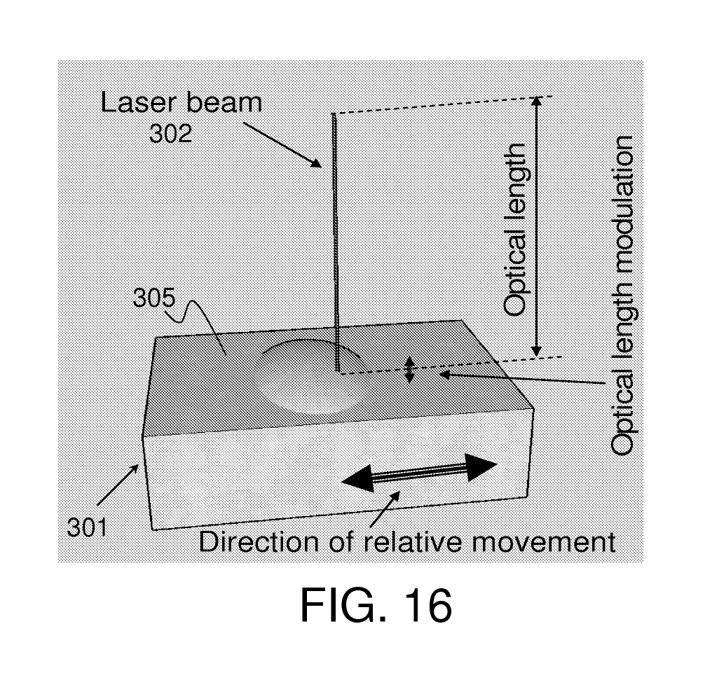

The relative movement 304 may induce an apparent out-of-plane movement due to the topography profile. The apparent out-of-plane movement may be defined by a velocity V and a distance S. With apparent out-of-plane movement is meant that the object 301 and the incident monochromatic electromagnetic wave 302 move in one direction, e.g. horizontally, with respect to one another, but that the reflected monochromatic electromagnetic wave 303 sees this as a motion in a second direction different from the first direction, for example perpendicular to the first direction, e.g. a vertical motion, due to the topography, e.g. curvature, of the surface 305, as for example shown in FIG. 16.

In particular embodiments of the present invention, the movement frequency F is different from the mechanical resonance frequency of the surface 305. A movement frequency F equal or close to the resonance frequency of the surface 305 could induce a deformation of the object which is not suitable for determining the topography profile of the object 301 in accordance with embodiments of the present invention.

The relative movement between the incident electromagnetic wave 302 and the surface 305 of the object 301 can be performed in one dimension or in two dimensions. Most important is that the movement is performed in a direction which is substantially not in the propagation direction of the incident monochromatic electromagnetic wave 302, for example in a direction substantially perpendicular to the propagation direction. The relative movement may be a reciprocating linear movement. The relative movement may be a circular movement.

The observed out-of-plane velocity V is given by:

$$Δ x = A \cdot sin ( Ft )$$

$$Δ y = α \cdot A \cdot sin ( Ft )$$

$$V = \frac{\partial }{\partial t} ( Δ y ) = F \cdot α \cdot A \cdot cos ( Ft )$$

where A is the vibration amplitude generated by the shaker at a frequency F, α is the average slope of the surface 305 at the measurement spot. X is determined by the shaker, and in particular embodiments is maximized. The average slope a of the surface 305 at the measurement spot A is a property of the sample, more specifically a property of the shape of the surface. It is a goal of embodiments of the present invention to be able to measure even very small a (e.g. α<=1e-3). F is chosen by the user, but in a practical implementation there will always be a trade-off between high shaker frequency F and high vibration amplitude A. Actually, in embodiments of the present invention it is desired to maximize the product F.A of the shaker. The minimum detectable out-of-plane velocity V is limited by the sensitivity of the system detecting the properties of the incident and reflected monochromatic electromagnetic wave (e.g. a vibrometer), and will also depend on the shaker frequency F. V may be detectable in a range from 5 μm/s to 800 mm/s. To give a numerical example: if shaking is performed at a frequency F of 100 kHz and a vibration amplitude A=1 μm is obtained, and the sample has a non-flatness of 1e-3 (=α), an out-of-plane velocity V about 600 μm/s will be obtained, which is still very acceptable.

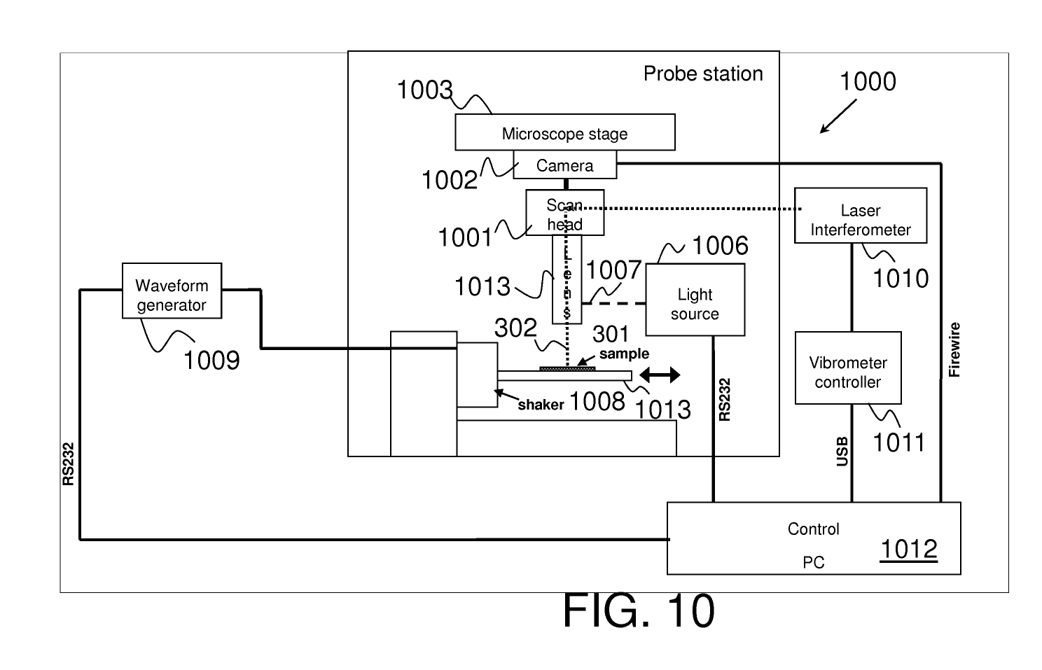

FIG. 10 is a schematic representation of an exemplary apparatus 1000 of embodiments of the present invention. A laser Doppler vibrometer scan head 1001 is mounted on a video port 1002 (e.g. C-mount adapter) of a standard microscope 1003. The laser beam 302 therefore falls substantially perpendicularly onto the sample 301, i.e. the object with a topography to be determined. The source 1006 of monochromatic electromagnetic radiation, e.g. laser source, may be connected to the scan head 1001 using an optical fiber 1007. In the embodiment illustrated the sample 301 is placed on a shaker stage 1008. The shaker stage 1008 induces a relative movement of the sample 301 with respect to the incident monochromatic electromagnetic wave 302. A waveform generator 1009 is used in order to generate a harmonic displacement of the sample 301 in a direction that is perpendicular to the incident monochromatic electromagnetic wave 302. In alternative embodiments of the present invention (not illustrated in the drawings), a shaker stage could induce a relative movement of the incident monochromatic electromagnetic wave with respect to the stationary sample, for example by placing the scan head on a shaker stage. In yet alternative embodiments (not illustrated in the drawings), both the sample and the incident monochromatic electromagnetic wave can be related to a shaker stage, so that both the sample and the incident monochromatic electromagnetic wave move with respect to each other.

The relative movement of the sample 301 may be defined by a movement frequency F and a movement amplitude A. A shaker 1008 may for example induce a displacement of the sample 301 with a frequency F of a few kHz, more specifically with a frequency below 100 kHz, more specifically with a frequency below 10 kHz and with an amplitude A of a few μm, more specifically in the range of 0.01 to 100 μm, more specifically in the range of 0.01 to 10 μm. The amplitude A may be larger than 100 μm, however this may not be the optimal amplitude for determining a topography profile with high resolution, i.e. sub-nm resolution. The movement amplitude A is typically as large as the defined region of the surface 305.

While inducing the relative movement of the object 301, hence its surface 305 and thus the defined region 301a, and the incident monochromatic electromagnetic wave 302 with respect to one another, the incident monochromatic electromagnetic wave 302 is reflected from the region 301a of the surface 305. Otherwise said the surface 305 reflects the incident monochromatic electromagnetic wave 302. The reflected monochromatic electromagnetic wave 303 may be defined by a frequency fᵣ, an amplitude Aᵣ and a phase P.

Measurements can be performed in the time domain and in the frequency domain. In alternative embodiments, measurements may be performed in the time domain.

In embodiments of the present invention, properties of the monochromatic electromagnetic wave 303 reflected from the region 301a during the movement 304 are determined. In particular embodiments, at least the frequency f, of the reflected monochromatic electromagnetic wave 303 is determined.

In order to determine the topography of the region 301a of the surface 305, properties of the incident monochromatic electromagnetic wave 302 and properties of the reflected monochromatic electromagnetic wave are analyzed to obtain information about the topography of the region 301a of the surface 305. In particular embodiments, properties, e.g. the frequency f₀, of the incident monochromatic electromagnetic wave 302 and properties, e.g. the frequency fᵣ, of the reflected monochromatic electromagnetic wave 303 are analyzed. The analysis of the frequency f₀ of the incident monochromatic electromagnetic wave 302 and the frequency fᵣ of the reflected monochromatic electromagnetic wave 303 is based on the Doppler effect.

If the surface 305 of the object 301 under investigation is curved (has a curved shape, profile), such a relative movement 304 in a direction not parallel to the propagation direction of the incident monochromatic electromagnetic wave 302, e.g. substantially perpendicular to the monochromatic electromagnetic wave 302, will result in a modulation of the length of the optical path between the source 300 of monochromatic electromagnetic wave 302 and the investigated surface 305 (as in FIG. 16). In the example illustrated, the object 301 (hence the surface 305) and the scanning monochromatic electromagnetic wave 302 move horizontally with respect to one another, but the reflected monochromatic electromagnetic wave 303 sees this as a vertical motion due to the curvature of the surface 305. The speed of such a length-modulation can be detected by a laser Doppler vibrometer and can be translated to the desired information about the shape of the unknown surface 305. In this way, one effectively measures the local slope of the region 301a of the surface 305.

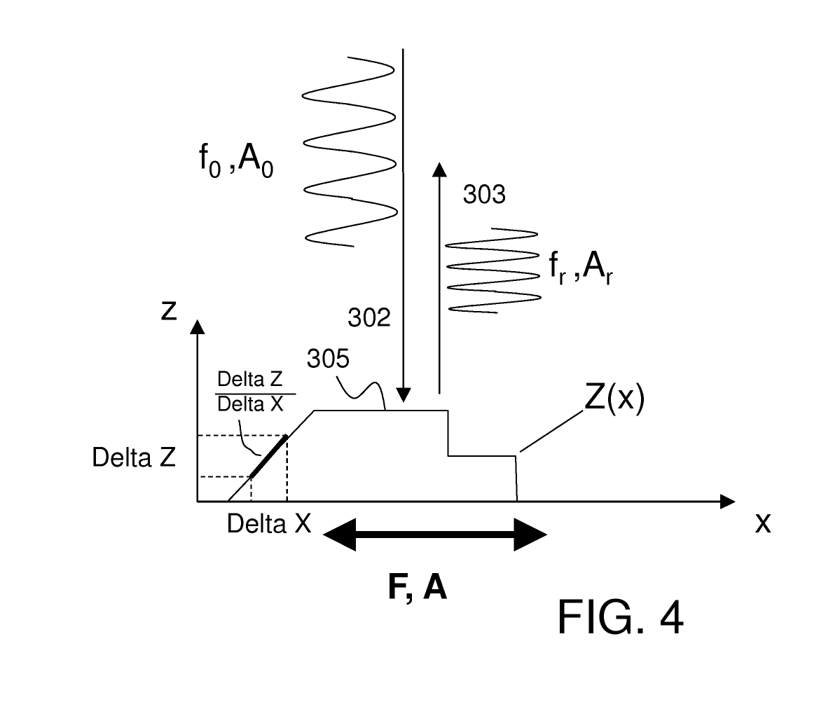

Contrary to other optical surface profiling techniques such as white light interferometry, the system according to embodiments of the present invention can be used to perform measurements through optical windows without any modifications. This is a significant advantage if measurements are to be done on devices in a controlled atmosphere (pressure, humidity, chemical composition and the like). The profile of topography of a surface may be defined by a height expressed as a function of a distance, z(x) [see FIG. 4]. According to particular embodiments of the present invention a Doppler shift frequency, Δf, is determined, i.e. the difference between the frequency f₀ of the incident monochromatic electromagnetic wave 302, and the frequency fᵣ of the reflected monochromatic electromagnetic wave 303. Using Doppler equations, the relationship between z(x) and Δf may be defined as:

$$Δ f ∝ \frac{Δ z}{Δ x} \cdot \frac{Δ x}{Δ t} , with \frac{Δ z}{Δ x}$$

being the slope of the topography profile z(x), i.e. displacement in height in function of the displacement in-plane and

$$\frac{Δ x}{Δ t}$$

being the speed of the shaker, i.e. the speed of the relative movement of the object to the monochromatic electromagnetic wave.

$$\frac{Δ x}{Δ t}$$

may be defined by the movement amplitude A and the movement frequency F. The relative movement may for example be at 100 μm per second.

In order to determine the topography profile z(x) the measured

$$\frac{Δ z}{Δ x}$$

may be integrated. This can be done using mathematical software or packages known by a person skilled in the art. For example the integration may be done using MatLab.

The minimum and maximum detectable Δf may be specified by the detector of the incident and reflected monochromatic electromagnetic waves 302, 303. The detection limit may for example be about 1 MHz.

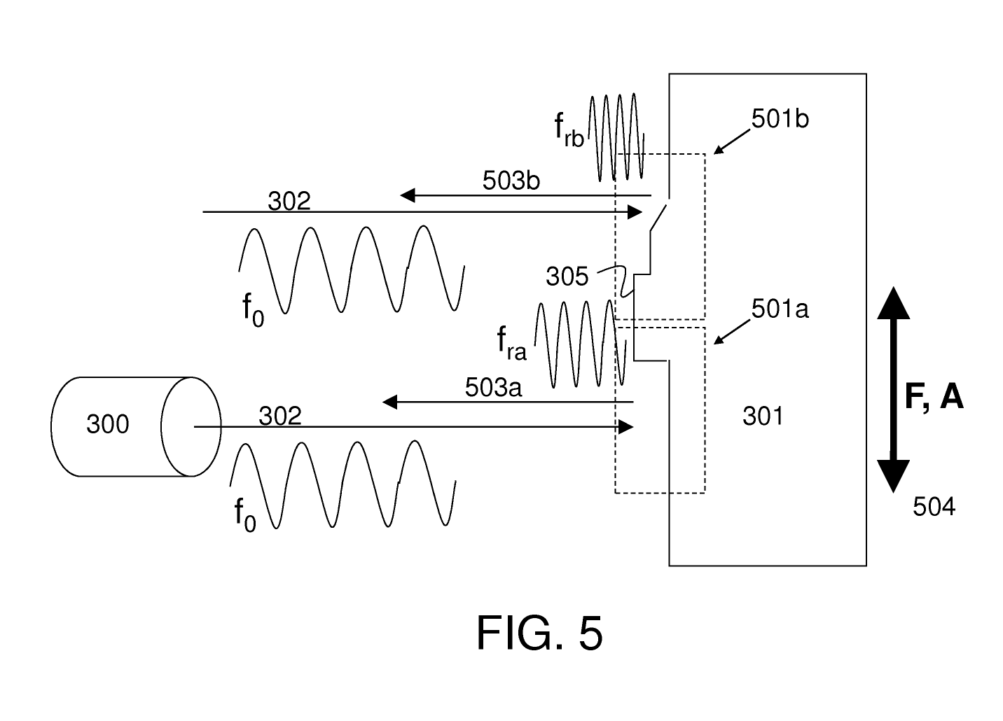

According to embodiments of the present invention after the step of analyzing the property, e.g. frequency f₀, of the incident monochromatic electromagnetic wave 302 and the property, e.g. frequency fᵣₐ, of the reflected monochromatic electromagnetic wave 503a to obtain information about the topography of the region 501a of the surface 305 of the object 301, the monochromatic electromagnetic wave 302 may be directed to another region 501b and steps (a) to (e) may be repeated for this another region 501b (FIG. 5). From analyzing the property, e.g. frequency f₀, of the incident monochromatic electromagnetic wave 302 and the property, e.g. frequency f_{rb}, of the reflected monochromatic electromagnetic wave 503b, information about the topography of the region 501b of the surface 305 of the object 301 may be obtained. Until the overall topography profile of the object is determined these steps may be repeated for all the regions of the object 301. One may choose to determine the topography profile of one region of the surface. One may also choose to determine the topography profile of more than one region of the surface as such determining the overall topography profile of the surface.

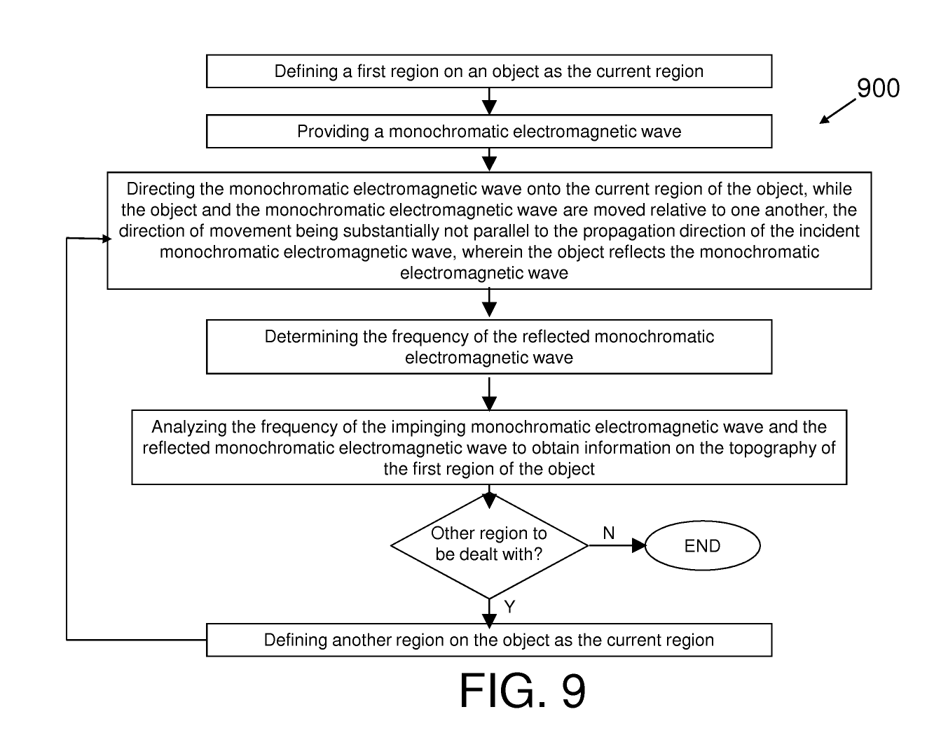

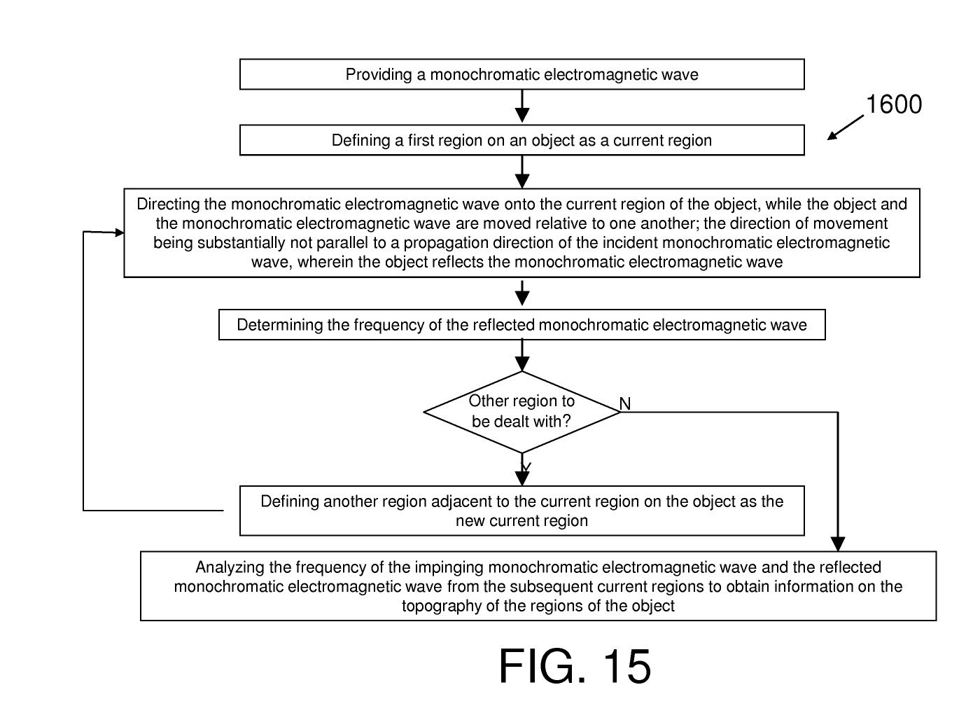

In particular embodiments, as illustrated schematically by method 900 in FIG. 9 and by method 1600 FIG. 15, a method as recited in any of the previous embodiments can be performed for determining the topography of a surface 305 wherein the surface 305 comprises at least two regions 501a, 501b. As illustrated in FIG. 9, the method of the present invention as described in any of the previous embodiments can be repeated at least once to obtain information about the at least two regions of the surface. By repeating steps (c) to (e) for another region one may obtain information about the overall topography of the surface. This may be done by combining the information about the topography of each regions 501a, 501b of the surface 305. The information about the topography of one of the plurality of regions may be determined before performing data capturing on another region, as illustrated in FIG. 9, or the information about the topography of the plurality of regions may be determined after having performed data capturing for all the regions, as illustrated in FIG. 15.

In a particular embodiment, a method as recited in any of the previous embodiments can be performed for determining the topography of a surface wherein the object 301 comprises a plurality of regions. The method of the present invention as described in any of the previous embodiments can be performed for each region of the plurality of regions to obtain information about the plurality of regions. This information for each region can be combined to obtain information about the overall topography of the object.

In an embodiment of the present invention, the source 300 of the monochromatic electromagnetic wave may be moved such that the monochromatic electromagnetic wave 302 impinges on each of the plurality of regions 501a, 501b of the surface 305. In an alternative embodiment, the object 301 may be moved such that the monochromatic electromagnetic wave 302 impinges on each of the plurality of regions 501a, 501b of the surface 305. In an alternative embodiment, both the source 300 of the monochromatic electromagnetic wave 302 and the surface 305 can be moved such that the monochromatic electromagnetic wave 302 impinges on each of the plurality of regions 501a, 501b of the surface 302. As such the electromagnetic wave 302 is scanned relative to the surface 305. This scanning may be done in a predetermined sequence, such as raster scanning.

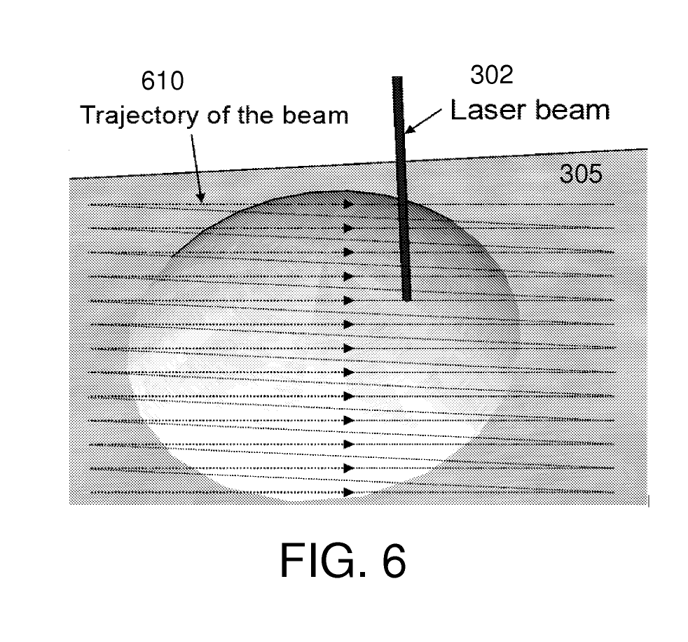

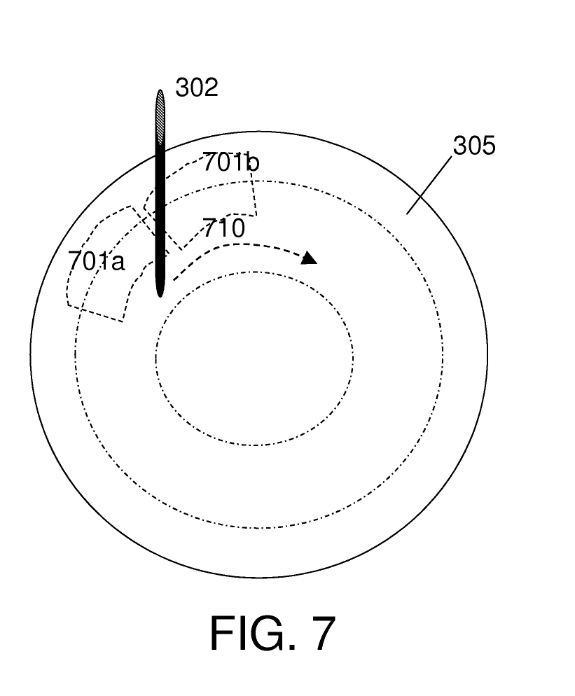

Directing the monochromatic electromagnetic wave 302 to a plurality of regions 501a, 501b of the surface 305 may be done by scanning the monochromatic electromagnetic wave 302 from one region to another region, the scanning being defined by a scanning velocity and a scanning distance. The scanning velocity is typically but not necessarily smaller than the movement velocity V (defined by the movement parameters such as frequency F, and amplitude, A). The scanning amplitude is equal to or larger than the movement amplitude A. According to embodiments of the present invention, raster scanning 610 may be performed by moving the monochromatic electromagnetic wave 302 from one region to another according to a two dimensional raster on the surface of the object (FIG. 6). According to alternative embodiments of the present invention, a circular scanning (FIG. 7) may be performed by moving the monochromatic electromagnetic wave 302 from one region 701a to another region 701b according to circular path 710 in a two dimensional way, subsequent circular paths having an increasing or decreasing diameter.

The surface 305 of which the topography is to be determined can be scanned in one dimension or in two dimensions with relatively slow speed using an electrically controllable positioner (XY stage). With relatively low speed is meant a scanning velocity smaller than 1 mm per second.

The surface 305 may be moved by a harmonic relative movement 304 (e.g. a reciprocating movement, shaking) of the surface 305 by means of suitable actuators, such as for example piezoelectric, magnetic or electrostatic actuators. The frequency and the amplitude of such vibrations can be adjusted to obtain an optimal resolution. This fast shaking has to be modulated by slow lateral displacements to scan over the whole surface of the object. This can be done by moving the incident monochromatic electromagnetic wave 302 or by moving the surface 305.

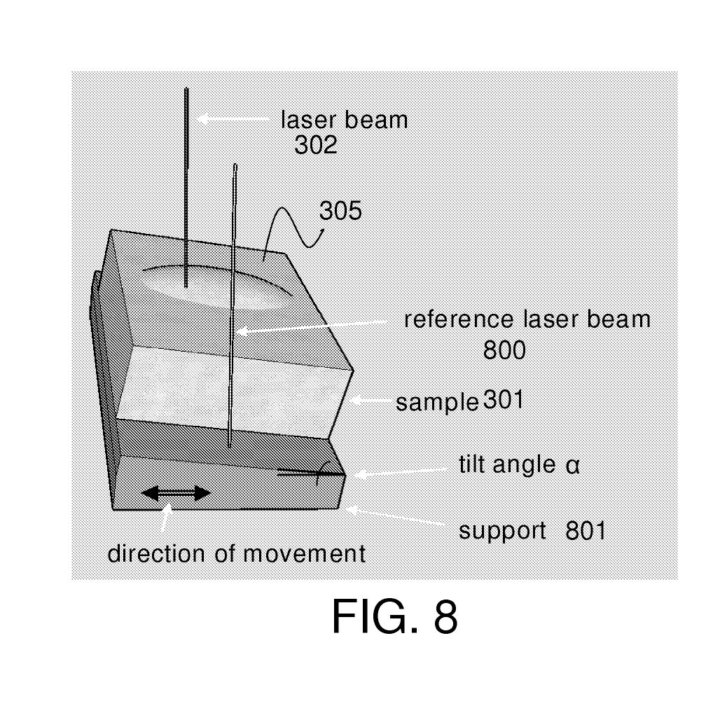

The scanning speed should be much smaller than the relative movement speed (shaking speed). Otherwise said, the frequency of the scanning should be much smaller than the frequency of the relative movement. Typically the scanning movement is in the order of less than 1 mm/s, while the relative (shaking) movement is in the order of 100 s or even 1000 s of mm/s. In the case when the object 301 is tilted, as illustrated in FIG. 8, the tilt angle β will contribute to the shape information. This tilt can be considered during the post processing of the raw data or it can be compensated for by pointing a reference monochromatic electromagnetic wave 800 of the laser Doppler vibrometer on to the flat but tilted surface of a sample holder 801 (as schematically indicated in FIG. 8).

In a second aspect of this invention, a system is disclosed for measuring topography of a static surface 305 using a monochromatic electromagnetic wave 302, the system comprising:
a holder to which the static surface 305 is attached;
a monochromatic electromagnetic wave source 300 for generating a monochromatic electromagnetic wave 302;
optics for directing the monochromatic electromagnetic wave (302) to the surface (305), so as to generate a reflected monochromatic electromagnetic wave (303) from the surface (305), the reflected monochromatic electromagnetic wave 303 having a frequency fᵣ, an amplitude Aᵣ and a phase.
a shaker to move the surface 305 and the monochromatic electromagnetic wave relative to one another, the direction of movement 304 being substantially not parallel to the propagation direction of the incident monochromatic electromagnetic wave 302, the movement being determined by a moving frequency F and moving amplitude A;
a detector for detecting the properties of the reflected monochromatic electromagnetic wave 303;
an analyzer for analyzing the properties of the incident monochromatic electromagnetic wave 302 and the properties of the reflected monochromatic electromagnetic wave 303;
a convertor for converting the analyzed data to a topography property of the surface 305.

The system may also further comprise a scanner for scanning the surface 305 with the monochromatic electromagnetic wave 302, wherein scanning the surface comprises a second relative movement of the monochromatic electromagnetic wave 302 from a first region 501a, 701a of the surface 305 towards a second region 501b, 701b of the surface 305, the second relative movement being substantially not parallel to the propagation direction of the incident monochromatic electromagnetic wave 302. The scanning amplitude may be equal or larger than the shaker amplitude.

In a third aspect of this invention, the use of the system as recited in embodiments of the second aspect of this invention is disclosed. The system as recited in any of the embodiments of the second aspect of this invention may be used for determining the topography of a static object in a non-destructive way.

According to an embodiment of the invention, the system of the present invention can be used to determine the topography of an object. The object may for example have a top surface of which the topography is to be determined. In a particular embodiment, the system as recited in any of the embodiments of the second aspect can be used for the determination of the topography of an object, the object having a surface, for example a top surface, which is curved. In this case, the monochromatic electromagnetic wave is directed to that surface, e.g. to the top surface, of the object while the object is moved relative to the monochromatic electromagnetic wave, the direction of movement being substantially not parallel to the propagation direction of the incident monochromatic electromagnetic wave, wherein the top surface of the object reflects the monochromatic electromagnetic wave.

A method according to embodiments of the present invention can be used to determine the topography of sample areas in the range from 1 μm up to several cm or even higher. Furthermore, this method allows an out-of-plane resolution of less than 1 nm, or less than 0.1 nm. The method can also be performed in different environments such as through glass of a vacuum or environmental chamber; for samples on a hot stage or the like.

### Experimental Example

In this particular example a Polytec MSV-400, which is a laser doppler vibrometer (LDV) tool was mounted on the video port (C-mount adapter) of a standard microscope. This system comprises the following units (see also FIG. 10):
an OFV-072 microscope adapter (scan head 1001 on FIG. 10), which couples the laser beam into a standard microscope 1003. A lens 1013 of the microscope 1003 focuses the laser beam onto the sample 301. The adapter 1001 features two beam adjustment units, one for a measurement beam and one for a reference beam. This allows one to perform differential displacement measurements using two laser beams pointed at different locations. One beam adjustment unit is equipped with two piezo-actuators. Using these actuators, the laser beam 302 can be programmatically moved in X- and Y-directions over the entire field-of-view (FOV) of the microscope 1003. The second beam adjustment unit is equipped with manually controlled deflecting mirrors. This beam can thus be manually positioned at any desired location within the FOV. If one does not require differential measurements, the laser fibre can be removed from the adjustment unit and terminated with a mirror attachment.
A Polytec OPV512 laser source 1006 emitting visible (red) light 1007 around 600 nm, and the optical fibre, which contains a beam splitter.
A laser interferometer 1010 for providing an interface between the measurement beam and the reference beam and for conversion into an electrical signal, and a vibrometer controller 1011, containing the hardware that processes the Doppler signal so as to transform it into analogue voltages that are proportional to either the velocity or the displacement.
A PC 1012 equipped with dedicated software which performs data processing and optionally visualisation of the results.
Additional software (MatLab code), which performs additional data processing to obtain information on the static shape of the object 301.
A piezoelectric actuator (MD-44 from Jodon Inc.) 1008 with the sample holder 1013, which is mounted in a way that a direction of its actuation is substantially perpendicular to the incident laser beam 302.
A waveform generator 1009 to provide oscillating voltage to the piezoelectric actuator 1008.

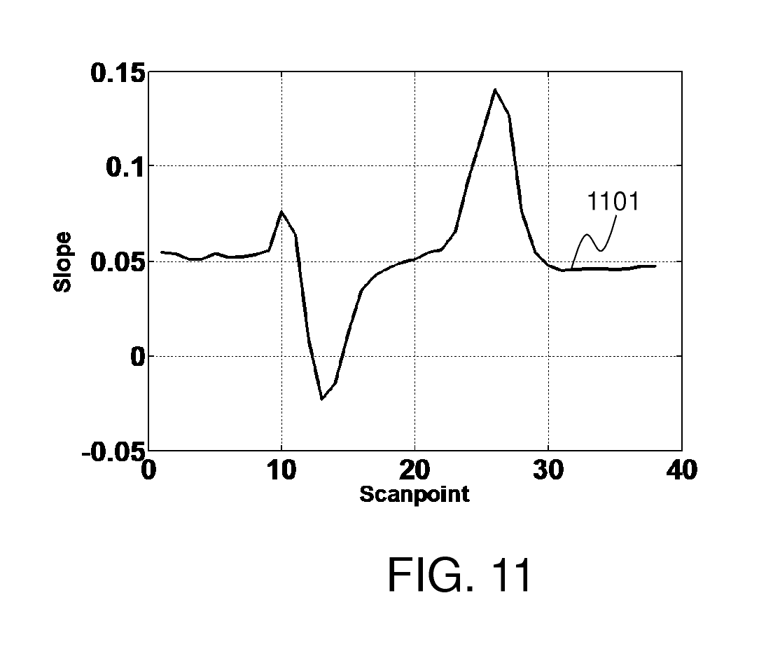

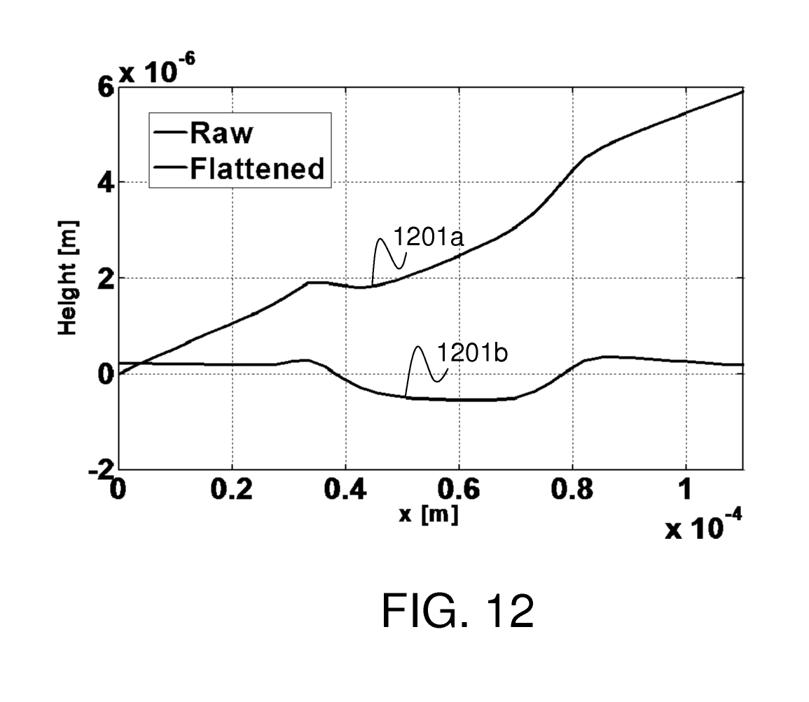

The experimental procedure comprises the following steps:
The sample 301 is glued to the sample holder 1013, which in turn is attached to the piezoelectric shaker 1008.
The laser beam 302 is pointed into the sample's surface 305.
The sinusoidal voltage emanating from the waveform generator 1009 is applied to the piezoelectric shaker 1008. This voltage is also used to trigger (synchronize) the vibrometer controller 1011.
The data acquisition is done using the software running on the PC unit 1012. The measured raw data 1101 are shown on FIG. 11.
The raw data 1101 were further processed in the MatLab program, which integrated this slope to get the topography of the sample 301 (as on FIG. 12, 1201a). The general tilt of the graph 1201a indicates that the sample holder 1013 was tilted.
This tilt has further been compensated for in the MatLab program. The final result is shown as line 1201b (“flattened” line) on FIG. 12.

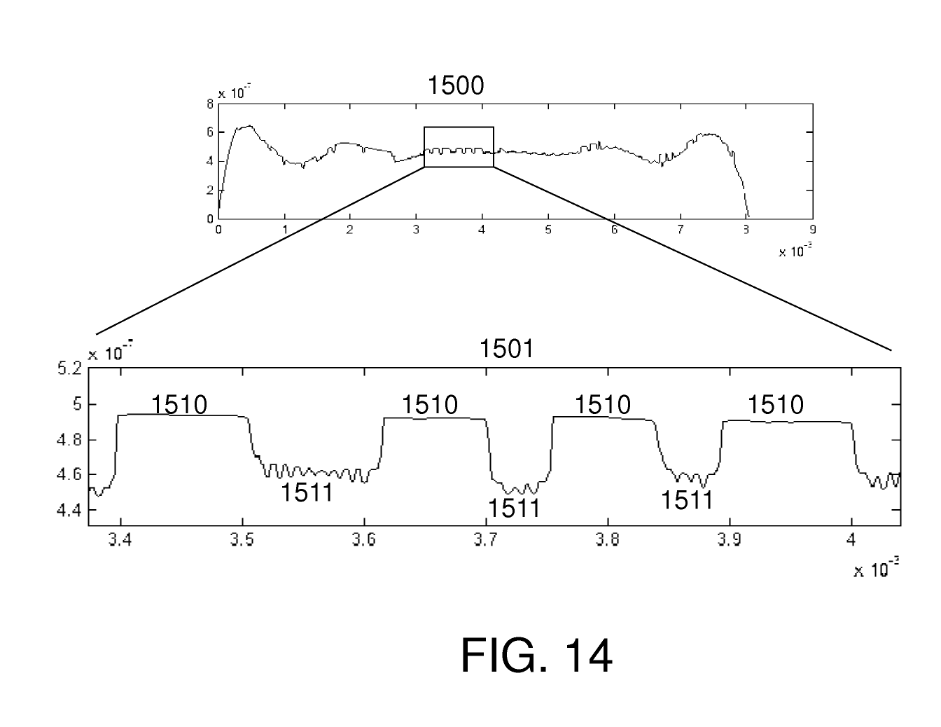

In another example an object 301 with a topography is mounted on a rotating stage, such as for example a CD drive. The object is a silicon die with SiGe structures on top. In FIG. 14, one sees a signal representing a number of SiGe bondpads and interconnects (the wide steps). In between the SiGe structures, there are dummy devices (these are 10 μm×10 μm SiGe bumps that are placed there in order to get an even fill of the SiGe layer during device processing). The dummy devices show up in the measurement as the small oscillations. The relative movement of the surface and the beam with respect to one another is thus the rotational movement of the object. The CD spins more than 4000 rpm FIG. 14 shows an overall profile of the measured frequency shift 1500 and a detailed part 1501. The height is plotted in function of the distance. A region of 9 μm is measured according to embodiments of the present invention. The profile shows large elevated sections 1510, which are probably bond pads which the laser bean travels across. The profile also shows small dimples 1511 in between which are the SiGe dummies with a pitch of 10 μm.

1-20. (canceled)

21. A method comprising:
selecting a region on a surface of an object;
directing onto the region an incident monochromatic electromagnetic wave while moving at least one of the surface and the incident monochromatic electromagnetic wave with a relative movement relative to one another, thereby generating a reflected monochromatic electromagnetic wave reflected from the surface, wherein:
the incident monochromatic electromagnetic wave has a frequency f₀, an amplitude A₀ and a propagation direction, and
the relative movement comprises a reciprocating linear movement that is substantially nonparallel to the propagation direction;
determining incident properties of the incident monochromatic electromagnetic wave and reflected properties of the reflected monochromatic electromagnetic wave; and
analyzing the incident properties and the reflected properties to determine information regarding the topography of the region.

22. The method of claim 21, wherein the surface is substantially preserved.

23. The method of claim 21, wherein the relative movement comprises displacement of at least one of the surface and the incident monochromatic electromagnetic wave.

24. The method of claim 23, wherein the displacement is induced by at least one of a mechanical, electromagnetic, or piezoelectric force applied to at least one of the surface and a source of the incident monochromatic electromagnetic wave.

25. The method of claim 23, wherein:
the relative movement comprises displacement of the incident monochromatic electromagnetic wave; and
the displacement is induced by moving at least one mirror located in a propagation path of the incident monochromatic electromagnetic wave.

26. The method of claim 23, wherein the displacement comprises a reciprocating displacement induced by providing a holder for a surface a source of the incident monochromatic electromagnetic wave and inducing the reciprocating displacement to the holder.

27. The method of claim 21, wherein an angle between the propagation direction of the incident monochromatic electromagnetic wave and the relative movement is substantially in the range of about 40 degrees to about 90 degrees.

28. The method of claim 27, wherein the angle is substantially 90 degrees.

29. The method of claim 21, wherein:
the incident properties comprise the frequency f₀; and
the reflected properties comprise a frequency fᵣ of the first reflected monochromatic electromagnetic wave.

30. The method of claim 29, wherein analyzing the incident properties and the reflected properties to determine information regarding the topography of the first region comprises:
determining a Doppler shift Δf, where the Doppler shift is substantially equal to a difference between f₀ and fᵣ;
determining a topographical slope value from Δf, a frequency F of the relative movement, and an amplitude A of the relative movement; and
integrating the topographical slope value to determine the information regarding the topography of the region.

31. The method of claim 30, wherein the frequency F of the relative movement differs from a mechanical resonance frequency of the object.

32. The method of claim 21, further comprising:
selecting at least one additional region on the surface;
for each additional region:
directing onto the additional region the incident monochromatic electromagnetic wave while moving at least one of the surface and the incident monochromatic electromagnetic wave with a relative movement relative to one another, thereby generating an additional reflected monochromatic electromagnetic wave reflected from the surface;
determining additional reflected properties of the additional reflected monochromatic electromagnetic wave; and
analyzing the incident properties and the additional reflected properties to determine information regarding the topography of the additional region.

33. The method of claim 32, wherein the region and the at least one additional region together comprise substantially the entire surface.

34. The method of claim 32, further comprising, prior to directing onto the additional region the incident monochromatic electromagnetic wave, moving the incident monochromatic electromagnetic wave from the region to the additional region with a scanning velocity V and a scanning amplitude S.

35. The method of claim 34, wherein moving the incident monochromatic electromagnetic wave comprises moving the incident monochromatic electromagnetic wave according to a predetermined path.

36. The method of claim 34, wherein moving the incident monochromatic electromagnetic wave comprises moving the incident monochromatic electromagnetic wave in one dimension or in two dimensions.

37. The method of claim 21, further comprising:
directing a reference monochromatic electromagnetic wave onto the surface, thereby generating a reflected reference monochromatic electromagnetic wave reflected from the surface;
determining reference properties of the reference monochromatic electromagnetic wave and reflected reference properties of the reflected reference monochromatic electromagnetic wave; and
analyzing the reference properties, the reflected reference properties, the incident properties, and the reflected properties to determine information regarding the topography of the region.

38. A system, comprising:
an object having a surface;
a monochromatic electromagnetic wave source configured to generate an incident monochromatic electromagnetic wave having a frequency f₀, an amplitude A₀ and a propagation direction;
optics configured to direct onto a region of the surface the incident monochromatic electromagnetic wave thereby generating a reflected monochromatic electromagnetic wave reflected from the surface;
a shaker configured to move at least one of the surface and the incident monochromatic electromagnetic wave with a relative movement relative to one another, wherein the relative movement comprises a reciprocating linear movement that is substantially nonparallel to the propagation direction and has a frequency F and an amplitude A;
a detector configured to detect reflected properties of the reflected monochromatic electromagnetic wave;
an analyzer configured to analyze incident properties of the incident monochromatic electromagnetic wave and the reflected properties to determine information regarding the topography of the region; and
a converter configured to convert the information into a topography property of the surface.

39. The system of claim 38, further comprising:
a scanner configured to induce an additional relative movement of the surface and the incident monochromatic electromagnetic wave, wherein the additional relative movement comprises a scanning movement from the region to an additional region with a velocity V and a distance S, wherein S is larger than A and V is smaller than F.

40. A method, comprising:
using a Laser Doppler vibrometer (LDV) to determine a topography of a surface, wherein using the LDV comprises inducing a reciprocating linear relative movement of a monochromatic electromagnetic wave and the surface in a direction substantially not parallel to a propagation direction of the monochromatic electromagnetic wave.
